(19) United States
(12) Patent Application Publication
(10) Pub. No.: US 2026/0171713 A1
(43) Pub. Date: Jun. 18, 2026

(54) WIRE-OUTGOING PROTECTION DEVICE

(71) Applicant: EmCom Technology Inc., Taipei City (TW)

(72) Inventor: Chu-Li Wang, Taipei City (TW)

(21) Appl. No.: 19/071,977

(22) Filed: Mar. 6, 2025

(30) Foreign Application Priority Data
Dec. 17, 2024 (TW) 113149134

(51) Int. Cl. H01R 13/58; H01R 13/506

(52) U.S. Cl. CPC H01R 13/5841; H01R 13/506; H01R 13/5845

(57) ABSTRACT

An electrical connector, a cable rotating device, a cable bending device, and a cable connection module are provided. The electrical connector includes a first electrical connecting unit and a cable connection module. The first electrical connecting unit includes a first end and a second end opposite each other. The first end is electrically connected to a cable and insertable into a corresponding second electrical connecting unit to electrically connect the cable to the second electrical connecting unit. A wire-outgoing direction extends outward from the second end. The cable connection module is adjacent to the second end and configured to rotate a first rotation angle along a plane perpendicular to the wire-outgoing direction, or a first turning angle along a plane parallel to the wire-outgoing direction. The cable extends out of the first electrical connecting unit from the second end and passes through the cable connection module.

### CROSS-REFERENCE TO RELATED APPLICATIONS

This application claims priority to Taiwanese Application No. 113149134, having a filing date of Dec. 17, 2024, the entire contents of which are hereby incorporated by reference.

### Technical Field

The present disclosure relates to an electrical connector, and a cable rotating device, a cable bending device and a cable connection module included therein, and in particular to an electrical connector connected to a cable carrying electronic signals, and a cable rotating device, a cable bending device and a cable connection module included therein.

### Background

Cables, such as telephone lines, optical fiber lines and Ethernet lines, are usually inserted into corresponding sockets in walls or other devices through electrical plugs connected therewith to complete the electrical connection.

In some cases, the cable outside the electrical plug needs to be bent because of, for example, a narrow space. However, the cable cannot easily maintain the bending position and angle due to an elasticity of the cable itself. Therefore, there is still room for improvement for the conventional electrical plugs.

### SUMMARY

An aspect of the present disclosure is to provide an electrical connector, and a cable rotating device, a cable bending device and a cable connection module included therein, which are convenient to use.

The electrical connector of the present disclosure includes a first electrical connecting unit and a cable connection module. The first electrical connecting unit includes a first end and a second end opposite to each other. The first end is electrically connected to a cable and insertable into a corresponding second electrical connecting unit to electrically connect the cable to the second electrical connecting unit. The first electrical connecting unit is one of an electrical plug and a socket. The second electrical connecting unit is the other of the electrical plug and the socket. A wire-outgoing direction extends outward from the second end. The cable connection module is adjacent to the second end and configured to rotate a first rotation angle along a plane perpendicular to the wire-outgoing direction or a first turning angle along a plane parallel to the wire-outgoing direction. The cable extends out of the first electrical connecting unit from the second end and passes through the cable connection module.

In an example of the present disclosure, the cable connection module includes a cable rotating device, arranged at the second end and configured to rotate a first rotation angle along a plane perpendicular to the wire-outgoing direction.

In an example of the present disclosure, the cable connection module includes a cable bending device pivoted to the second end and configured to rotate a first turning angle along a plane parallel to the wire-outgoing direction and then being fixed. The cable extends out of the first electrical connecting unit from the second end and passes through the cable bending device. A part of the cable passing through the cable bending device is configured to form the first turning angle with the wire-outgoing direction.

In an example of the present disclosure, the cable connection module includes a cable bending device pivoted to an opposite side of the cable rotating device relative to the second end and configured to rotate a first turning angle along a plane parallel to the wire-outgoing direction and then being fixed. The cable passes through the cable bending device after extending out of the first electrical connecting unit from the second end and passing through the cable rotating device. The part of the cable passing through the cable bending device is configured to form the first turning angle with the wire-outgoing direction.

In an example of the present disclosure, a joint between the cable rotating device and the cable bending device is provided with a limiting device, and the limiting device is configured to fix the cable bending device rotating the first turning angle.

In an example of the present disclosure, the limiting device includes a plurality of recesses and a protrusion. The plurality of recesses are arranged at an opposite side of the cable rotating device relative to the second end along a circumferential direction. The protrusion is arranged at a side of the cable bending device connected to the cable rotating device and detachably snaps in the recesses.

The cable rotating device of the present disclosure is for use with a first electrical connecting unit. The first electrical connecting unit includes a first end and a second end opposite to each other. The first end is connected to a cable and insertable into a corresponding second electrical connecting unit to electrically connect the cable to the second electrical connecting unit. The first electrical connecting unit is one of an electrical plug and a socket. The second electrical connecting unit is the other of the electrical plug and the socket. A wire-outgoing direction extends outward from the second end. The cable rotating device is arranged at the second end and configured to rotate a first rotation angle along a plane perpendicular to the wire-outgoing direction. The cable extends out of the first electrical connecting unit from the second end and passes through the cable rotating device.

The cable bending device of the present disclosure is for use with a first electrical connecting unit. The first electrical connecting unit includes a first end and a second end opposite to each other. The first end is connected to a cable and insertable into a corresponding second electrical connecting unit to electrically connect the first electrical connecting unit to the second electrical connecting unit. The first electrical connecting unit is one of an electrical plug and a socket. The second electrical connecting unit is the other of the electrical plug and the socket. A wire-outgoing direction extends outward from the second end. The cable bending device is pivoted to the second end and configured to rotate a first turning angle along a plane parallel to the wire-outgoing direction and then being fixed. The cable extends out of the first electrical connecting unit from the second end and passes through the cable bending device. The part of the cable passing through the cable bending device is configured to form the first turning angle with the wire-outgoing direction.

The cable connection module of the present disclosure is for use with a first electrical connecting unit. The first electrical connecting unit includes a first end and a second end opposite to each other. The first end is connected to a cable and insertable into a corresponding second electrical connecting unit to electrically connect the cable to the second electrical connecting unit. The first electrical connecting unit is one of an electrical plug and a socket. The second electrical connecting unit is the other of the electrical plug and the socket. A wire-outgoing direction extends outward from the second end. The cable connection module includes a cable rotating device and a cable bending device. The cable rotating device is arranged at the second end and configured to rotate a first rotation angle along a plane perpendicular to the wire-outgoing direction. The cable bending device is pivoted to an opposite side of the cable rotating device relative to the second end and configured to rotate a first turning angle along a plane parallel to the wire-outgoing direction and then being fixed. The cable passes through the cable bending device after extending out of the first electrical connecting unit from the second end and passing through the cable rotating device. The part of the cable passing through the cable bending device is configured to form the first turning angle with the wire-outgoing direction.

### BRIEF DESCRIPTION OF THE DRAWINGS

FIG. 1A is a schematic view of an electrical connector according to an example of the present disclosure;

FIG. 1B is a schematic view of an electrical connector according to an example of the present disclosure;

FIG. 2A is a schematic exploded view of the electrical connector according to an example of the present disclosure;

FIG. 2B is a schematic exploded view of the electrical connector according to an example of the present disclosure;

FIG. 2C is a schematic view showing a wire-outgoing direction extending outward from a second end according to an example of the present disclosure;

FIG. 2D is a schematic view showing a wire outgoing direction extending outward from a second end according to an example of the present disclosure;

FIG. 2E is a schematic view showing a wire outgoing direction extending outward from a second end according to an example of the present disclosure;

FIG. 3A is a schematic view showing a cable bending device in the electrical connector rotating to a specific angle according to an example of the present disclosure;

FIG. 3B is a schematic view showing a cable bending device in the electrical connector rotating to a specific angle according to an example of the present disclosure;

FIG. 4 is a schematic sectional view of the electrical connector according to an example of the present disclosure;

FIG. 4A is a schematic view showing a cable rotating device in the electrical connector rotating to a specific angle according to an example of the present disclosure;

FIG. 4B is a schematic view showing a cable rotating device in the electrical connector rotating to a specific angle according to an example of the present disclosure;

FIG. 5 is a schematic view showing that both the cable bending device and the cable rotating device in the electrical connector rotate according to an example of the present disclosure;

FIG. 6A is a schematic view of the electrical connector according to a different example of the present disclosure; and

FIG. 6B is a schematic exploded view of the electrical connector according to a different example of the present disclosure.

### DETAILED DESCRIPTION

Embodiments of connecting components disclosed in the present disclosure will be described with reference to specific examples and drawings. Those skilled in the art can understand the advantages and effects of the present disclosure from the contents disclosed in this specification. However, the following contents are not intended to limit the scope of protection of the present disclosure, and those skilled in the art can implement the present disclosure in other different examples based on different viewpoints and applications without departing from the spirit of the concept of the present disclosure. In the accompanying drawings, the thicknesses of layers, films, panels, areas, etc. are exaggerated for clarity. Throughout this specification, similar reference numerals refer to similar elements. It should be understood that when an element such as a layer, film, area or substrate is referred to as being “on” or “connected to” another element, it may be directly on or connected to the another element, or there may be an intervening element. On the contrary, when an element is defined to be “directly on” or “directly connected to” another element, there is no intervening element. As used herein, “connection” may refer to a physical and/or electrical connection. Further, “electrical connection” or “coupling” can mean that other elements exist between two elements.

It should be understood that although the terms “first”, “second”, “third” and the like can be used herein to describe various elements, components, areas, layers and/or parts, these elements, components, areas and/or parts should not be limited by these terms. These terms are only used to distinguish one element, component, area, layer or part from another element, component, area, layer or part. Therefore, the “first element”, “component”, “area”, “layer” or “part” discussed below can be referred to as a second element, component, area, layer or part without departing from the teachings herein.

In addition, relative terms such as “lower” or “bottom” and “upper” or “top” can be used herein to describe the relationship between one element and another, as shown in the figures. It should be understood that relative terms are intended to include different orientations of the device other than those shown in the figures. For example, if the device in one drawing is turned over, the element described as being on the “lower” side of the other element will be oriented on the “upper” side of the other element. Thus, the exemplary term “lower” may include orientations of “lower” and “upper”, depending on the specific orientation of the drawing. Similarly, if the device in one drawing is turned over, the element described as being “below” or “under” the other element will be oriented “above” the other element. Thus, the exemplary term “under” or “below” may include both upper and lower orientations.

As used herein, “about”, “approximately” or “substantially” includes the stated value and the average value within the acceptable deviation range of the specific value determined by those skilled in the art, taking into account the particular amount of measurement and measurement-related error discussed (i.e., the limitations of the measurement system). For example, “about” may mean within one or more standard deviations of the value, or within ±30%, ±20%, ±10% and ±5%. Furthermore, the term “about”, “approximately” or “substantially” used herein may choose a more acceptable deviation range or standard deviation according to optical properties, etching properties or other properties, without having to apply one standard deviation to all properties.

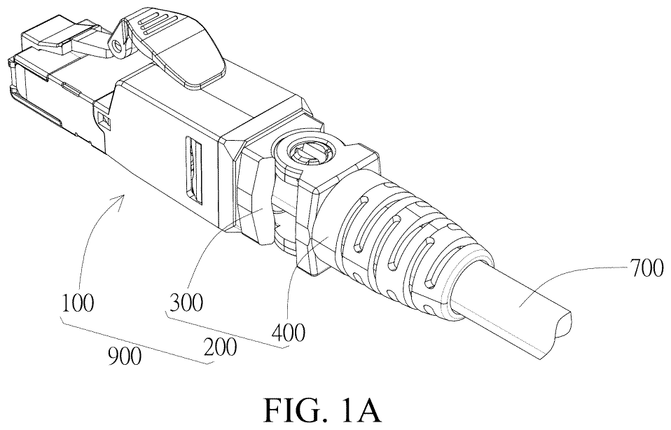

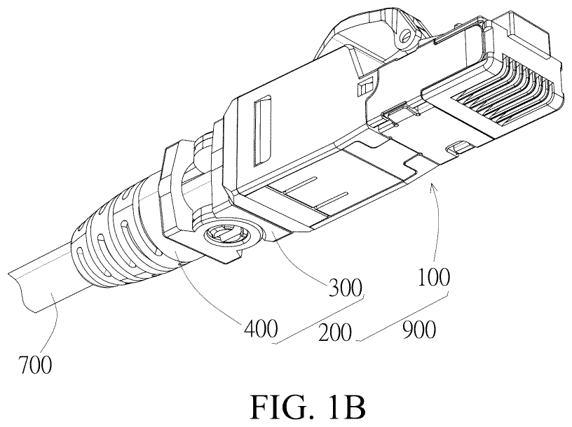

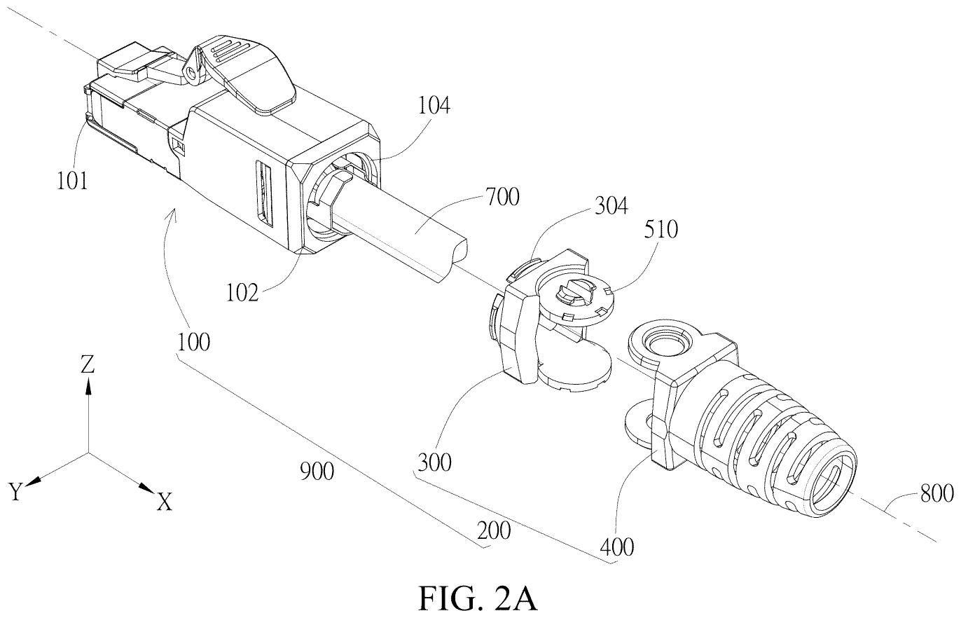

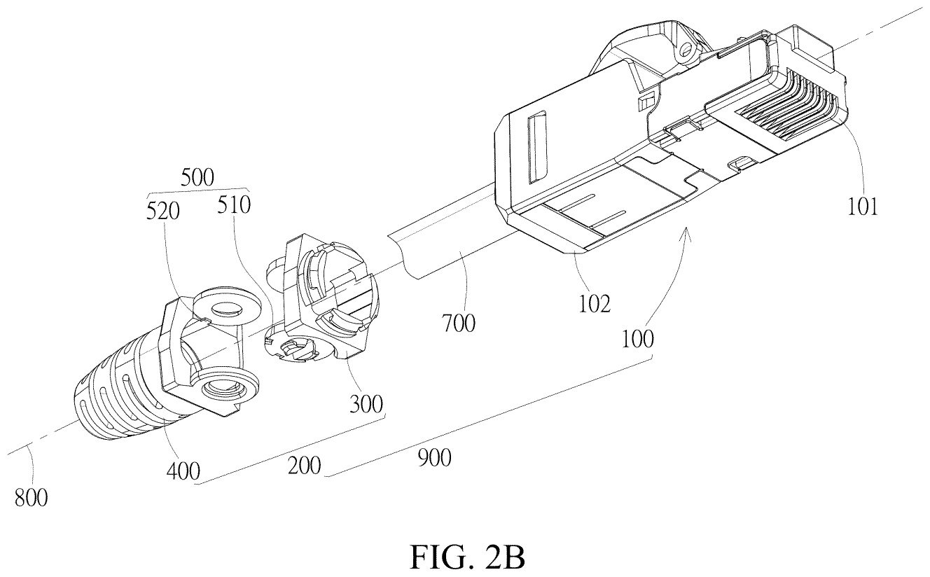

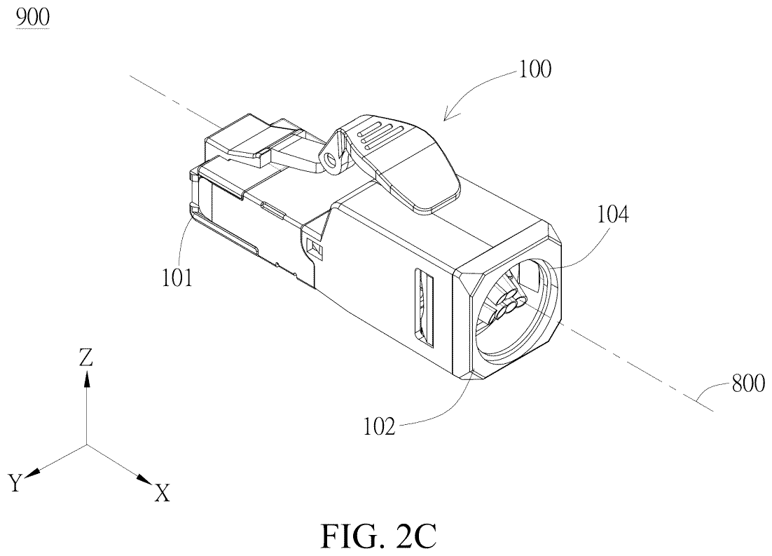

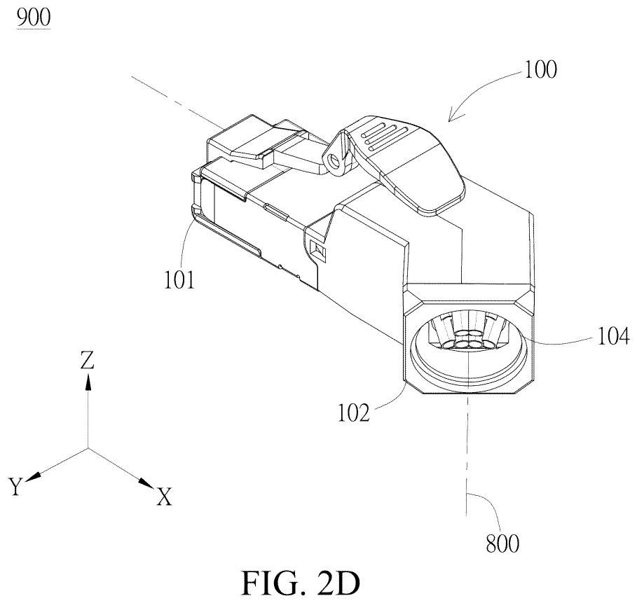

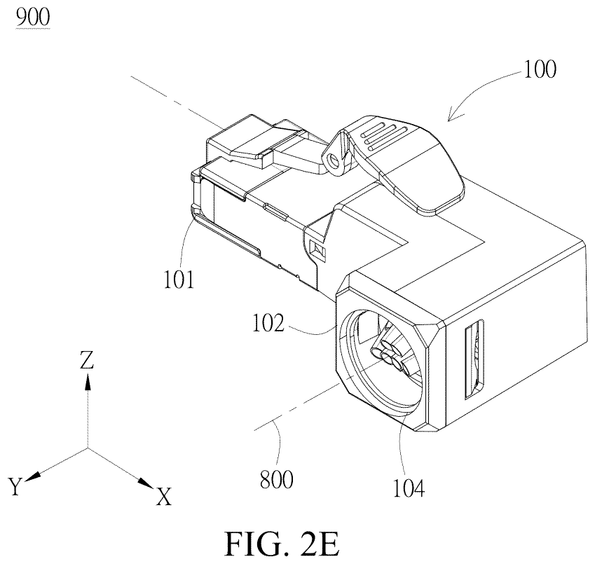

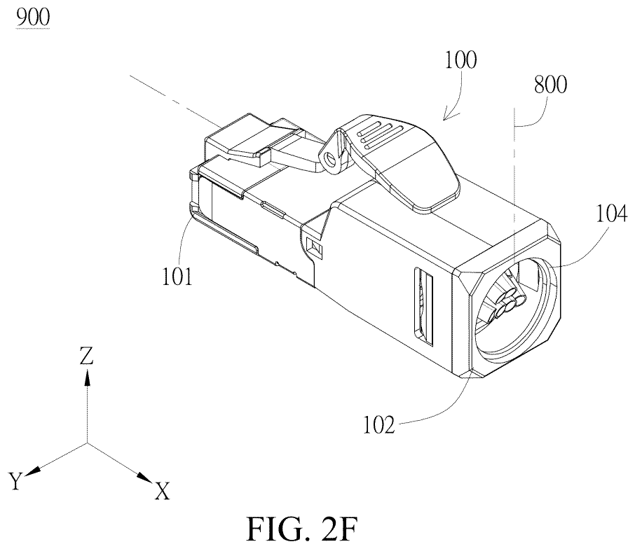

In an example shown in FIG. 1A and FIG. 1B, an electrical connector 900 of the present disclosure includes a first electrical connecting unit 100 and a cable connection module 200. The first electrical connecting unit 100 can carry electronic or optical signals. More specifically, in an example shown in FIG. 2A and FIG. 2B, the first electrical connecting unit 100 includes a first end 101 and a second end 102 opposite to each other. The first end 101 is electrically connected to a cable 700, and insertable into a corresponding second electrical connecting unit (not shown) and fastened therewith to electrically connect the cable 700 to the second electrical connecting unit. In this example, the first electrical connecting unit 100 and the second electrical connecting unit are respectively an electrical plug and a socket. However, in a different example, the first electrical connecting unit 100 and the second electrical connecting unit are respectively a socket and an electrical plug.

In an example shown in FIG. 2C, a wire-outgoing direction 800 extends outward from the second end 102. Further, in an example shown in FIG. 2D and FIG. 2E, the first electrical connecting unit 100 may be designed, for example, with different bending angles according to needs. Viewed from different angles, at least part of the first electrical connecting unit 100 extends along the wire-outgoing direction 800. In another aspect, in a different example shown in FIG. 2F, the wire-outgoing direction 800 may extend outward from the second end 102 and be substantially perpendicular to the first electrical connecting unit 100. The cable connection module 200 is adjacent to the second end 102 and configured to rotate a first rotation angle along a plane perpendicular to the wire-outgoing direction 800 or a first turning angle along a plane parallel to the wire-outgoing direction 800. The cable 700 extends out of the first electrical connecting unit 100 from the second end 102 and passes through the cable connection module 200.

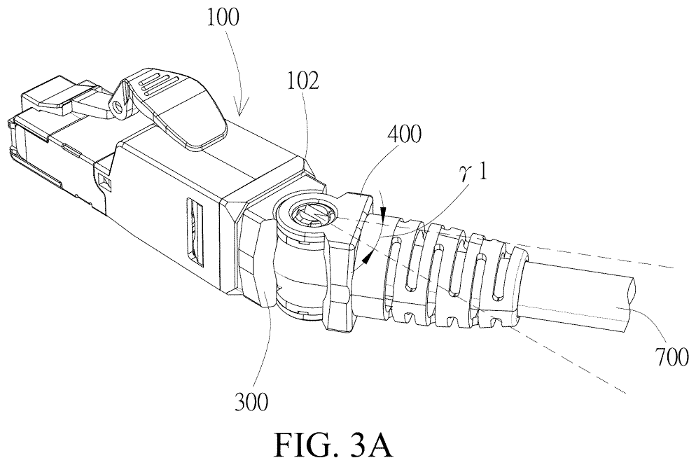

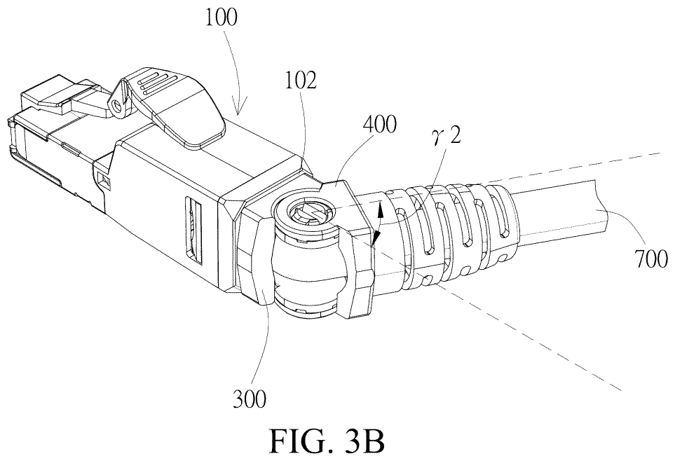

In the example shown in FIG. 2A and FIG. 2B, the cable connection module 200 includes a cable rotating device 300 and a cable bending device 400. The cable bending device 400 is pivoted to an opposite side of the cable rotating device 300 relative to the second end 102 and configured to rotate a first turning angle along a plane (e.g., XY plane) parallel to the wire-outgoing direction 800 and then being fixed. More specifically, in the example shown in FIG. 2B, a joint between the cable rotating device 300 and the cable bending device 400 is provided with a limiting device 500. The limiting device 500 includes a plurality of recesses 510 and a protrusion 520. The plurality of recesses 510 are arranged at an opposite side of the cable rotating device 300 relative to the second end 102 along a circumferential direction. The protrusion 520 is arranged at a side of the cable bending device 400 connected to the cable rotating device 300 and detachably snaps in the recesses 510. Accordingly, in an example shown in FIG. 3A and FIG. 3B, the cable bending device 400 may be rotated to a specific angle such as γ1 or γ2 and then be fixed.

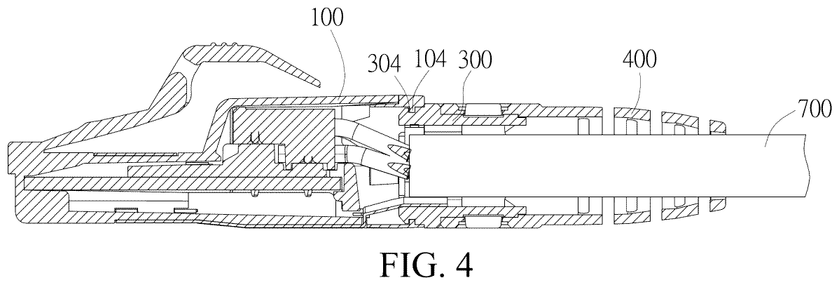

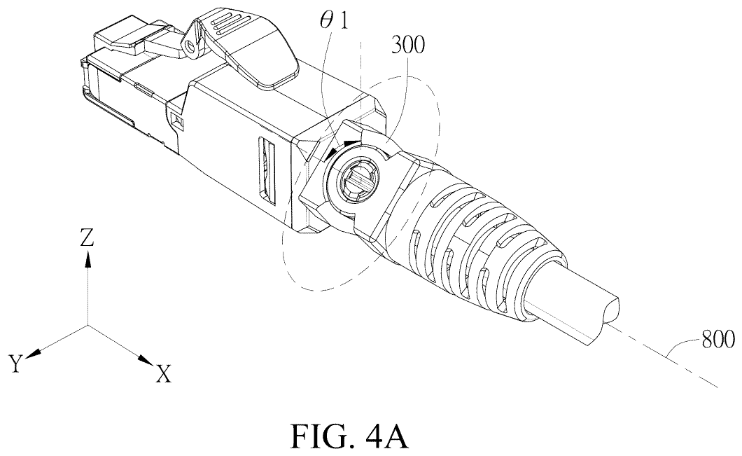

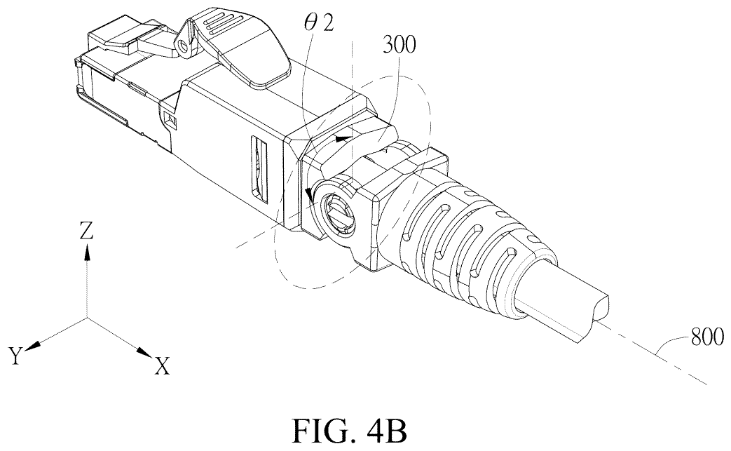

In the example shown in FIG. 2A and FIG. 2B, the cable rotating device 300 is arranged at the second end 102 and configured to rotate a first rotation angle along a plane (e.g., YZ plane) perpendicular to the wire-outgoing direction 800. More specifically, a side of the cable rotating device 300 close to the second end 102 has a groove 304, and the second end 102 is provided with a flange 104 corresponding to the groove 304. In an example shown in FIG. 4, the flange 104 movably snaps in the groove 304. Accordingly, in an example shown in FIG. 4A and FIG. 4B, the cable rotating device 300 is configured to rotate to any angle such as θ1 or θ2 relative to the wire-outgoing direction 800.

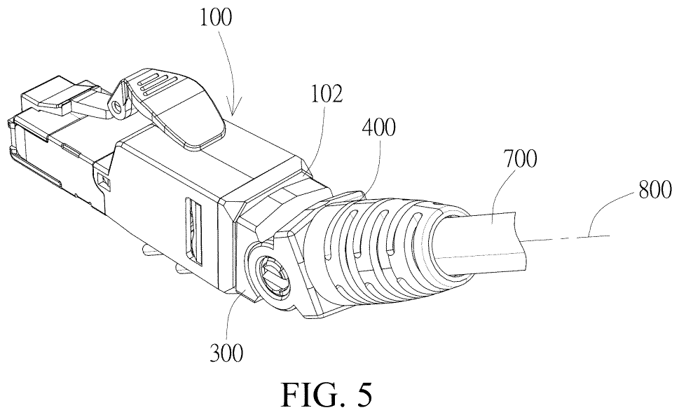

Further, in an example shown in FIG. 5, the cable rotating device 300 and the cable bending device 400 may respectively rotate along a plane perpendicular to the wire-outgoing direction 800 and a plane parallel to the wire-outgoing direction 800 to required angles and then be fixed. The cable 700 passes through the cable bending device 400 after extending out of the first electrical connecting unit 100 from the second end 102 and passing through the cable rotating device 300. A part of the cable 700 passing through the cable bending device 400 is configured to form an angle which is the same as the angle the cable bending device 400 rotates, with the wire-outgoing direction 800. Therefore, the problem that the cable 700 cannot easily maintain the bending position and angle due to its elasticity can be alleviated. In addition, when the above adjustments are made, there is no need to demount the cable rotating device 300 and the cable bending device 400, which is convenient to use.

In the above example, the cable connection module 200 includes the cable rotating device 300 and the cable bending device 400. However, in a different example, the cable connection module 200 may only include the cable rotating device 300 or the cable bending device 400 alone, that is, the cable rotating device 300 and the cable bending device 400 may be respectively used with the first electrical connecting unit alone. Further, when the cable bending device is used with the first electrical connecting unit alone, the cable bending device is pivoted to the second end and configured to rotate a first turning angle along a plane parallel to the wire-outgoing direction and then being fixed, the cable extends out of the first electrical connecting unit from the second end and passes through the cable bending device, and the part of the cable passing through the cable bending device is configured to form the first turning angle with the wire-outgoing direction. Viewed from different angles, the cable rotating device, the cable bending device, the cable connection module including the cable rotating device and the cable bending device, and the electrical connector including the cable connection module and the first electrical connecting unit can all protect the wire-outgoing of the cable, and thus, can all be regarded as a wire-outgoing protection device.

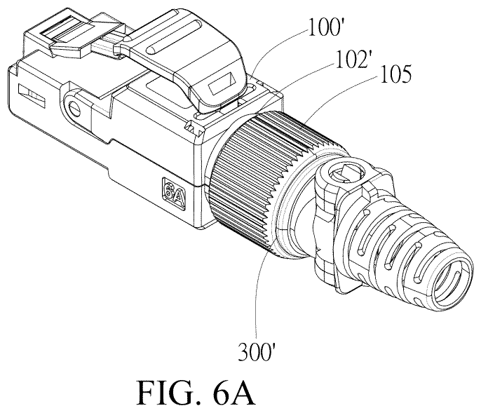

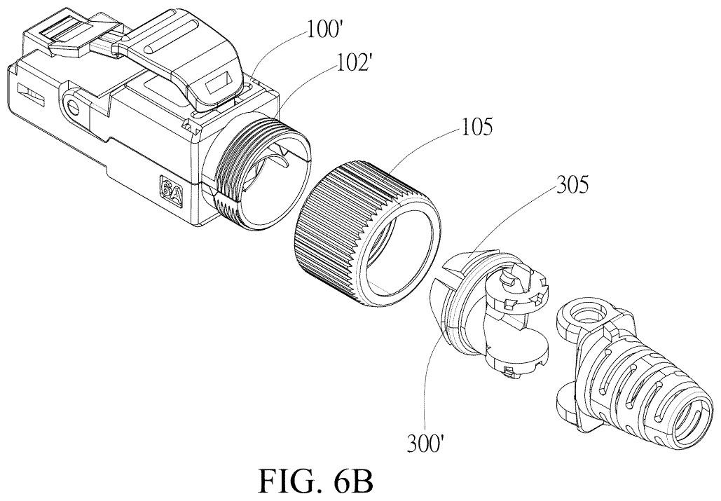

In an example shown in FIG. 6A and FIG. 6B, a second end 102′ of a first electrical connecting unit 100′ may further include a limiting device 105 such as a sleeve, and a side of a cable rotating device 300′ close to the second end 102′ may be provided with, for example, a corresponding limiting portion 305 having a slope. After the cable rotating device 300′ rotates to a required angle, the limiting device 105 may be rotated to tightly clamp the limiting portion 305 so as to fix the cable rotating device 300′.

The present disclosure has been described by the above related examples, but the above examples are only examples for implementing the present disclosure. It should be noted that the disclosed examples do not limit the scope of the present disclosure. On the contrary, modifications and equivalents included in the spirit and scope of the claims are included in the scope of the present disclosure.

What is claimed is:

1. An electrical connector, comprising:
a first electrical connecting unit, comprising a first end and a second end opposite to each other, the first end being electrically connected to a cable and insertable into a corresponding second electrical connecting unit to electrically connect the cable to the second electrical connecting unit, wherein the first electrical connecting unit is one of an electrical plug and a socket, the second electrical connecting unit is the other of the electrical plug and the socket, and a wire-outgoing direction extends outward from the second end; and
a cable connection module, adjacent to the second end and configured to rotate a first rotation angle along a plane perpendicular to the wire-outgoing direction or a first turning angle along a plane parallel to the wire-outgoing direction and then being fixed, the cable extending out of the first electrical connecting unit from the second end and passing through the cable connection module.

2. The electrical connector according to claim 1, wherein the cable connection module comprises a cable rotating device, arranged at the second end and configured to rotate a first rotation angle along a plane perpendicular to the wire-outgoing direction.

3. The electrical connector according to claim 2, wherein the cable connection module comprises a cable bending device pivoted to an opposite side of the cable rotating device relative to the second end and configured to rotate a first turning angle along a plane parallel to the wire-outgoing direction and then being fixed, the cable passes through the cable bending device after extending out of the first electrical connecting unit from the second end and passing through the cable rotating device, and a part of the cable passing through the cable bending device is configured to form the first turning angle with the wire-outgoing direction.

4. The electrical connector according to claim 2, wherein the cable connection module comprises a cable bending device pivoted to the second end and configured to rotate a first turning angle along a plane parallel to the wire-outgoing direction and then being fixed, the cable extends out of the first electrical connecting unit from the second end and passes through the cable bending device, and a part of the cable passing through the cable bending device is configured to form the first turning angle with the wire-outgoing direction.

5. The electrical connector according to claim 4, wherein a joint between the cable rotating device and the cable bending device is provided with a limiting device, and the limiting device is configured to fix the cable bending device rotating the first turning angle.

6. The electrical connector according to claim 5, wherein the limiting device comprises:
a plurality of recesses, arranged at an opposite side of the cable rotating device relative to the second end along a circumferential direction; and
a protrusion, arranged at a side of the cable bending device connected to the cable rotating device and detachably snapping in the recesses.

7. A cable rotating device for use with a first electrical connecting unit, wherein the first electrical connecting unit comprises a first end and a second end opposite to each other, and the first end is connected to a cable and insertable into a corresponding second electrical connecting unit to electrically connect the cable to the second electrical connecting unit, wherein the first electrical connecting unit is one of an electrical plug and a socket, the second electrical connecting unit is the other of the electrical plug and the socket, and a wire-outgoing direction extends outward from the second end,
wherein the cable rotating device is arranged at the second end and configured to rotate a first rotation angle along a plane perpendicular to the wire-outgoing direction, and the cable extends out of the first electrical connecting unit from the second end and passes through the cable rotating device.

8. A cable connection module for use with a first electrical connecting unit, wherein the first electrical connecting unit comprises a first end and a second end opposite to each other, and the first end is connected to a cable and insertable into a corresponding second electrical connecting unit to electrically connect the cable to the second electrical connecting unit, wherein the first electrical connecting unit is one of an electrical plug and a socket, the second electrical connecting unit is the other of the electrical plug and the socket, and a wire-outgoing direction extends outward from the second end, the cable connection module comprising:
a cable rotating device, arranged at the second end and configured to rotate a first rotation angle along a plane perpendicular to the wire-outgoing direction; and
a cable bending device, pivoted to an opposite side of the cable rotating device relative to the second end and configured to rotate a first turning angle along a plane parallel to the wire-outgoing direction and then being fixed, the cable passing through the cable bending device after extending out of the first electrical connecting unit from the second end and passing through the cable rotating device, and a part of the cable passing through the cable bending device being configured to form the first turning angle with the wire-outgoing direction.

9. The cable connection module according to claim 8, wherein a joint between the cable rotating device and the cable bending device is provided with a limiting device, and the limiting device is configured to fix the cable bending device rotating the first turning angle.

10. The cable connection module according to claim 9, wherein the limiting device comprises:
a plurality of recesses, arranged at an opposite side of the cable rotating device relative to the second end along a circumferential direction; and
a protrusion, arranged at a side of the cable bending device connected to the cable rotating device and detachably snapping in the recesses.
